(19) United States
(12) Patent Application Publication
(10) Pub. No.: US 2007/0171219 A1
(43) Pub. Date: Jul. 26, 2007

(54) System and method of early rejection after transformation in a GPU

(75) Inventor: You-Ming Tsao, Taipei (TW)

Correspondence Address: TROXELL LAW OFFICE PLLC, SUITE 1404, 5205 LEESBURG PIKE, FALLS CHURCH, VA, 22041, US

(73) Assignee: SMedia Technology Corporation

(21) Appl. No.: 11/335,572

(22) Filed: Jan. 20, 2006

(51) Int. Cl. G06T 15/00

(52) U.S. Cl. 345/419

(57) ABSTRACT

A system of early rejection after transformation in a Graphics Processing Unit is disclosed. The system includes following elements: (1) a vertex cache, for receiving vertex data of a triangle from system memory or video memory and storing the vertex data; (2) a vertex shader arithmetic logic unit, for operating the vertex data and related statuses of the vertex data; (3) a early rejection after transformation device, for determining if the triangle is valid or invalid via referring the related statuses of the vertex data of the triangle; (4) a lighting and texture stage program, for lighting and texturing the triangle determined valid to vertex information; (5) an index cache, for receiving index data from a driver to assemble the vertex data into primitives; and (6) a clip module, for performing a clipping operation on the valid triangle passed by the early rejection after transformation device.

### BACKGROUND OF THE INVENTION

1. Field of the Invention

The present invention relates generally to graphics processing, and more particularly, to a system and method of early rejection after transformation in a Graphics Processing Unit (GPU). The present invention can be applied to a portable hand-help device, such as, but not limited to, Digital Still Camera (DSC), Digital Video (DV), Personal Digital Assistant (PDA), mobile electronic device, 3G mobile phone, cellular phone or smart phone.

2. Description of the Prior Art

For mobile multimedia applications, supporting both video and graphics is a promising trend. Different from desktop graphics processors, mobile graphics processors operate in resource-limited environments and are power-limited since they are battery-powered. Recently, more and more research works are targeted on mobile graphics processors. KAMEYAMA M. and KATO Y teach “3D graphics LSI core for mobile phone “Z3D””, in Proc. Graphics Hardware '03 (2003), pp. 60-67. The disclosure of KAMEYAMA M. and KATO Y. is the first chip which integrates both dedicated geometry engine and rendering engine. However, only fixed graphics pipeline is supported by this chip. The first vertex shader for mobile devices is disclosed in “A programmable vertex shader with fixed-point SIMD datapath for low power wireless applications” in Proc. Graphics Hardware '04 (2004) by SOHN J.-H., et al. Fixed-point datapath is used instead of floating-point in order to save the power consumption and hardware cost. However, the floating-point data path is still required for precisely rendering complicated scenes. Munshi et al. disclose in U.S. Pat. No. 6,919,908 that a triangle clipping computation is used only.

Although the conventional vertex shaders perform shading operations on every vertex, after sending the vertices to the rendering stage, many primitives will be found to be invisible on the screen by the render processor, and a lot of processing power has been wasted on these primitives. If these primitives can be found early in the geometry stage after transformation, the lighting operation, which takes the heavy workload, can be omitted, thus a lot of vertex operations can be saved.

Therefore, a novel architecture for the purpose of saving many vertex operations is urged. Three types of triangles should be early rejected right after the vertex shader transforms the vertices form object space to clip space including triangles outside clipping boundary; triangles with zero area, that is, it does not cover any grid point in the screen; and back-faced triangles. The last type of triangle rejection depends on the culling mode decided by the applications. For some applications, this type of triangles should not be rejected from the pipeline.

### SUMMARY OF THE INVENTION

An objective of the present invention is to solve the above-mentioned problems and to provide a system and method of early rejection after transformation that reduces the computation in geometry stage resulting in improving the polygon rate and saving the power.

The present invention achieves the above-indicated objective by providing a system of early rejection after transformation in a Graphics Processing Unit. The system includes following elements: (1) a vertex cache, for receiving vertex data of a triangle from system memory or video memory and storing the vertex data; (2) a vertex shader arithmetic logic unit, for operating the vertex data and related statuses of the vertex data; (3) a early rejection after transformation device, for determining if the triangle is valid or invalid via referring the related statuses of the vertex data of the triangle; (4) a lighting and texture stage program, for lighting and texturing the triangle determined valid to vertex information; (5) an index cache, for receiving index data from a driver to assemble the vertex data into primitives; and (6) a clip module, for performing a clipping operation on the valid triangle passed by the early rejection after transformation device.

According to another aspect of the present invention, a method of early rejection after transformation in a Graphics Processing Unit first transforms vertex data of primitives into transformed vertex in a clipping space. Next, the primitives are determined valid or invalid via judging if any one triangle is outside clipping boundary, a back-faced triangle or has zero area by using the two-dimension screen position data. Next, the valid primitives are lighted and textured to vertex information. Finally, the vertex information is submitted

The following detailed description, given by way of example and not intended to limit the invention solely to the embodiments described herein, will best be understood in conjunction with the accompanying drawings.

### BRIEF DESCRIPTION OF THE DRAWINGS

FIG. 1 is a block diagram of a system of early rejection after transformation in a GPU of the present invention.

FIG. 2 is a block diagram of the early rejection after transformation device of the present invention.

FIG. 3 is a flow chart showing the steps for a method of early rejection after transformation in a GPU of the present invention.

FIG. 4 is a flow chart showing a preferred scheme of a detail determination procedure of the present invention.

FIG. 5 is a conceptual diagram for illustrating triangles outside clipping boundary.

FIG. 6 is a conceptual diagram for illustrating back-faced triangles.

FIG. 7 is a conceptual diagram for illustrating triangles with zero area.

FIG. 8 is a flow chart showing a preferred scheme of a detail procedure for judging any one triangle with zero area of the present invention.

### DETAILED DESCRIPTION OF THE PREFERRED EMBODIMENTS

The present invention discloses a system and method of early rejection after transformation in a GPU that is applicable to a portable hand-help device, such as, but not limited to, Digital Still Camera (DSC), Digital Video (DV), Personal Digital Assistant (PDA), mobile electronic device, 3G mobile phone, cellular phone or smart phone.

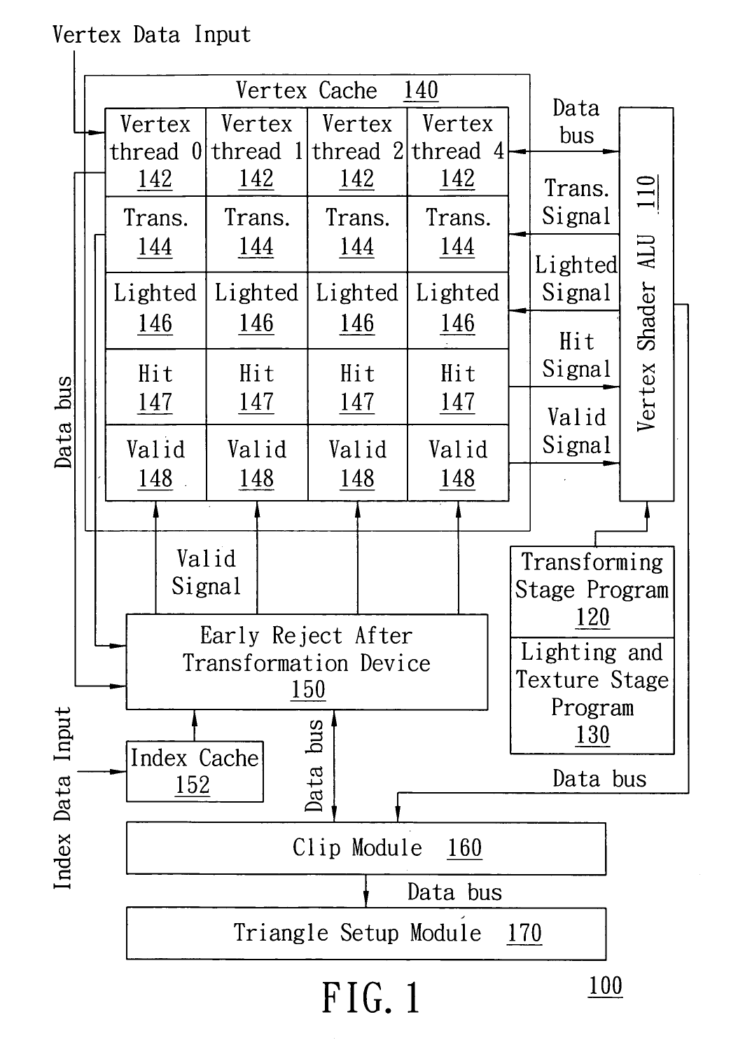

FIG. 1 is a block diagram of a system of early rejection after transformation in a GPU of the present invention. As shown in FIG. 1, the system 100 comprises a vertex shader arithmetic logic unit (ALU) 110, a transforming stage program 120, a lighting and texture stage program 130, a vertex cache 140, a early rejection after transformation device 150, an index cache 152, a clip module 160 and a triangle setup module 170.

The vertex cache 140 is used for receiving vertex data 142 from a system memory or video memory and storing the vertex data 142 and related statuses of the vertex data including Transformed flag 144, Lighted flag 146, Hit flag 147 and Valid flag 148. Each Transformed flag 144 represents whether transforming stage of the corresponding vertex is finished or not. Each Hit flag represents whether any vertex has been cache hit to prevent duplicated instructions in the same vertex. The vertex shader ALU 110 is used for operating the vertex data 142. The early rejection after transformation device 150 is used for determining if each triangle is valid or invalid via referring the related statuses of the vertex data of the each triangle. The vertex that is denoted as valid in the vertex cache 140 can only pass to the following lighting and texture stage program 130. The lighting and texture stage program 130 is used for lighting and texturing the triangle determined valid to vertex information. The index cache 152 is used for receiving index data from a driver to assemble the vertex data 142 into primitives. The clip module 160 is used for performing a clipping operation on the valid triangle passed by the early rejection after transformation device 150. Arrows in FIG. 1 represent directions of data flow.

Each vertex data 142 is put into a corresponding position of the vertex cache 140 and Valid flag 148 is turned on when the vertex data 142 received form the outer system memory or video memory. According to the Valid flag 148, the vertex shader ALU 110 realizes whether the vertex data 142 needed to be operated are read in the vertex cache 140 or not. If the vertex data 142 are valid, the transforming stage program 120 is performed and all vertexes in the vertex cache 140 are transformed sequentially and the Transformed flag 144 is turned on.

According to the Transformed flag 144, the early rejection after transformation device 150 realizes which vertexes are transformed. Next, based on index data of the index cache 152, the transformed vertexes are assembled to transformed primitives. The transformed vertexes are performed reject test to judge if any one vertex is really valid or not. If there is an invalid vertex exists, the Valid flag 148 of the invalid vertex will be turned off; otherwise the Valid flag 148 does not change. According to the Valid flag 148, the really valid vertexes are lighted and textured sequentially when the vertex shader ALU 110 performs the lighting and texture stage program 130. The lighted flag 146 of the lighted and textured vertexes will be turned on. It is noted that, the early rejection after transformation device 150 of the present invention can reject an invalid triangle and clip a valid triangle.

Since the vertex data 142 have repeatability, hits can occur for the vertex cache 140. In this architecture, the process of numerous duplicate vertex data 142 repeatedly read from an outer system memory or video memory can be avoided. Therefore, the Hit flag 147 will turned on to inform the vertex shader ALU 110 need not perform the transforming stage program 120, even the lighting and texture stage program 130 when cache hits occur. Since the Hit flag 147 represents that the hits have been operated once, duplicate processes do not need. In this architecture, bandwidth of memory read is reduced as well as duplicate calculations are eliminated resulting in numerous power saved.

Since the system 100 has the mechanism of the cache hits, the processes of transforming, lighting and texturing operated repeatedly can be avoided. However the system 100 has the mechanism of the rejection, the Transformed flag 144 of the vertex cache 140 is turned on, the Valid flag 148 is turned off and the lighted flag 146 is also turned off due to the vertex invalid when a primitive is rejected. As a result, when a new primitive is operated and a hit of vertexes of the new primitive occurs, that is the new primitive has the same vertex as a former primitive, the vertex with the hit is also needed to be lighted and textured by the vertex shader ALU 110 and the calculations can not be omitted if the new primitive is determined valid by the early rejection after transformation device 150. Although there is a former primitive with a hit, the new primitive is not lighted and textured resulting form the former primitive rejected. Therefore, the new primitive needs to be lighted compensatively. Thus, the lighting calculation is still needed to be performed when the lighting and texture stage program 130 is proceeded as well as the Hit flag 147 is turned on and the Lighted flag 146 is turned on.

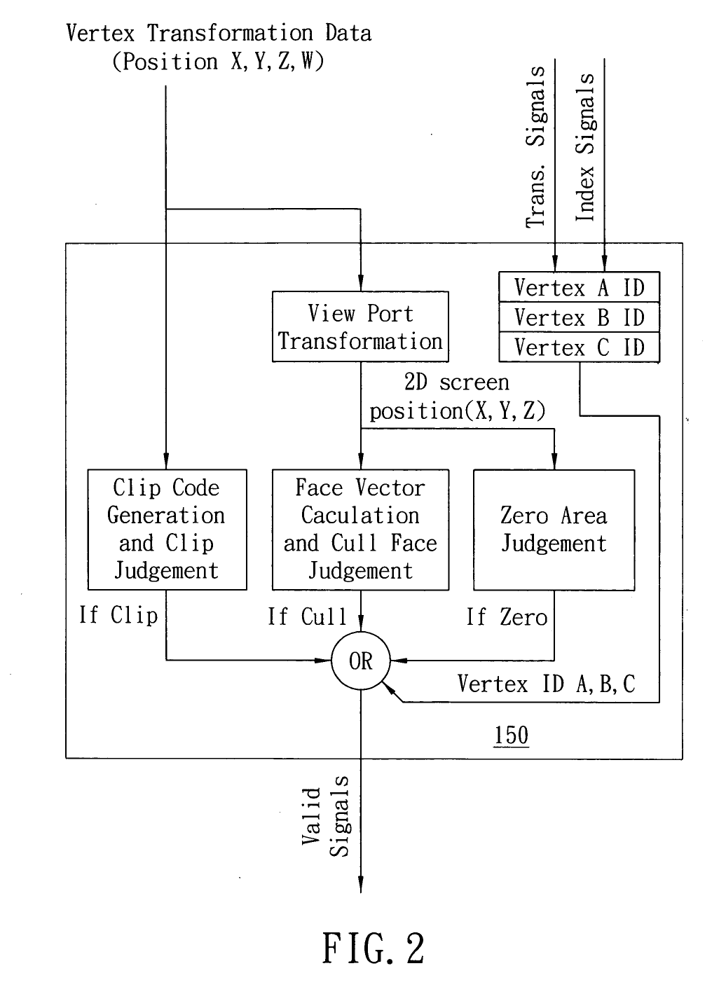

FIG. 2 is a block diagram of the early rejection after transformation device of the present invention. As shown in FIG. 2, each position of the three vertices of a triangle are each recorded in the index cache 152 naming as Vertex A ID, Vertex B ID and Vertex C ID, and pass to the early rejection after transformation device. That is, the early rejection after transformation device 150 has the position information of the current operating triangle in the vertex cache 140. Via Vertex A ID, Vertex B ID and Vertex C ID, the early rejection after transformation device 150 can realize where to read Transformation Data, Trans. Signals and perform View Port Transformation that transform three-dimension into two-dimension projection. That is, primitive coordinates of three-dimension are projected onto two-dimension coordinates on a screen of a display. Clip code generation module uses six bits to represent six quadrants of up, down, left, right, front and back for judging vertices of a triangle within or outside which quadrants. The algorithm for judging vertices of a triangle within or outside which quadrants is a prior art, so without further descriptions here. If a triangle outside the screen or not can be judged by the early rejection after transformation device 150 after clip code generated by the clip code generation module.

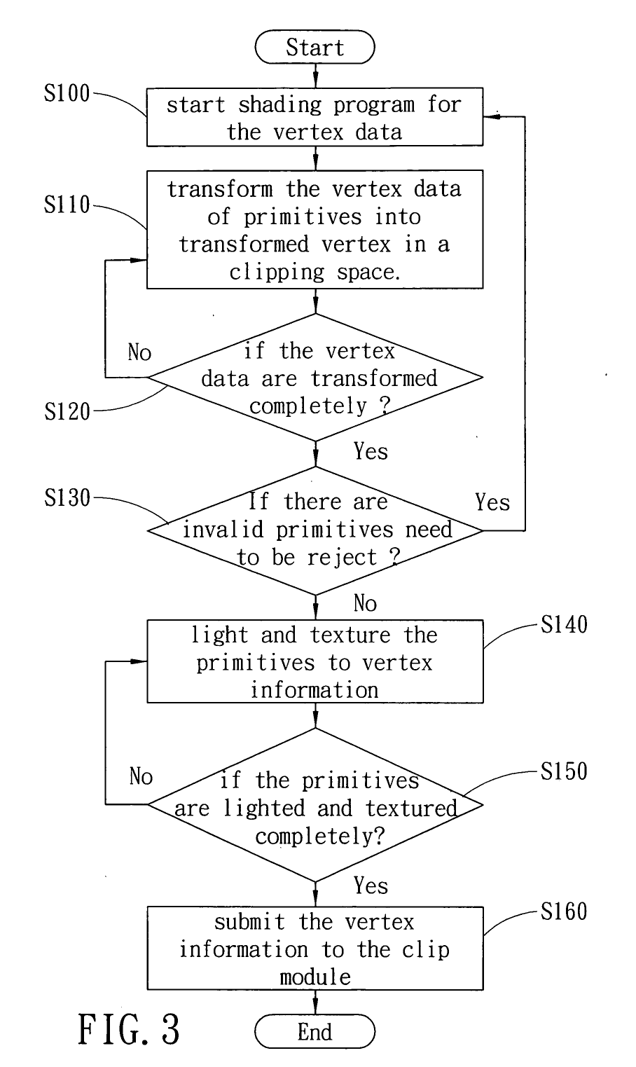

FIG. 3 is a flow chart showing the steps for a method of early rejection after transformation in a GPU of the present invention. The procedure first starts shading program for the vertex data of the vertex cache 140, as shown in step S100.

In step S110, the vertex data of primitives are transformed into transformed vertex in a clipping space.

In step S120, if the vertex data are transformed completely, the procedure goes to step S130; otherwise the procedure goes back to step Silo.

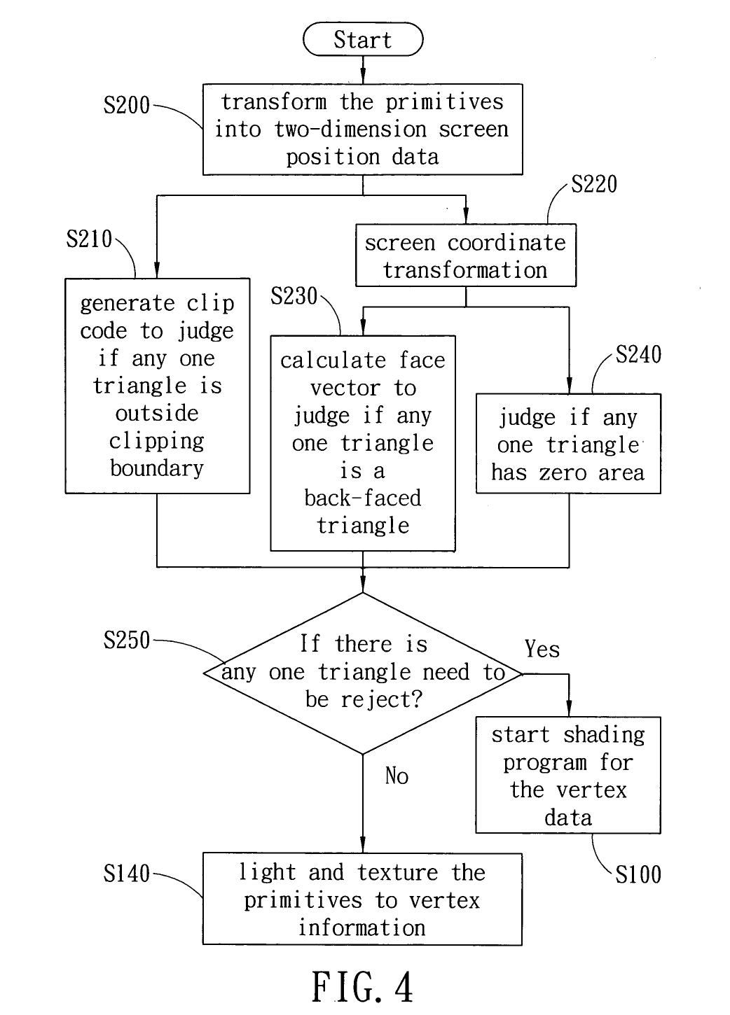

In step S130, the primitives are determined valid or invalid. If there are invalid primitives need to be reject, the procedure goes back to step S100; otherwise the procedure goes to step S140. FIG. 4 is a flow chart showing a preferred scheme of a detail determination procedure. Firstly, the primitives are transformed into two-dimension screen position data, as shown in step S200.

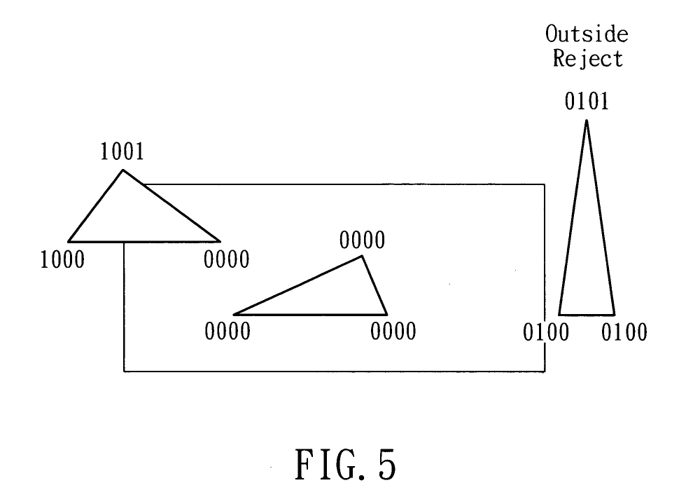

In step S210, the clipping space position data are used to generate clip code to judge if any one triangle is outside clipping boundary, as shown in FIG. 5.

In step S220, the two-dimension screen position data are used to generate screen coordinate transformation.

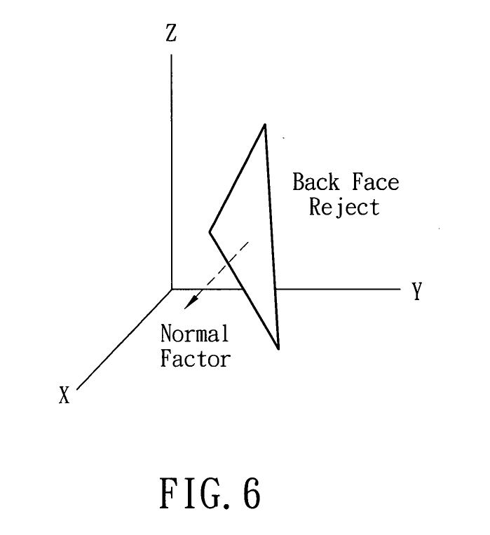

In step S230, the two-dimension screen position data are used to calculate face vector to judge if any one triangle is a back-faced triangle, as shown in FIG. 6.

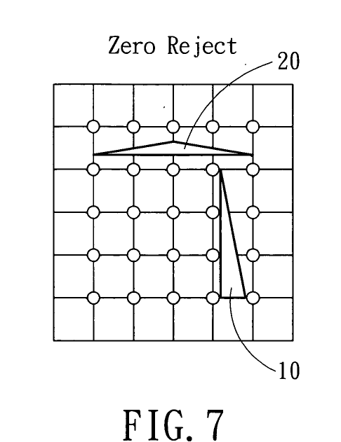

In step S240, the two-dimension screen position data are used to judge if any one triangle has zero area, that is, it does not cover any grid point in the screen, as shown in FIG. 7. Wherein, a triangle 10 is the triangle with zero area of X direction and can not be displayed in a screen as well as need to be reject when X integer coordinate of three vertices of the triangle 10 are all the same and not in an integer point. A triangle 20 is the triangle with zero area of Y direction and can not be displayed in a screen as well as need to be reject when Y integer coordinate of three vertices of the triangle 20 are all the same and not in an integer point.

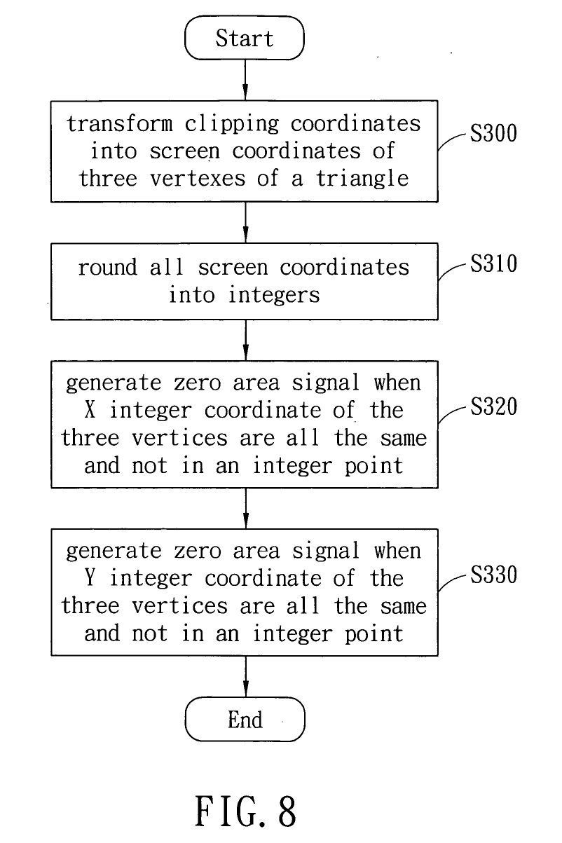

FIG. 8 is a flow chart showing a preferred scheme of a detail procedure for judging any one triangle with zero area. Firstly, clipping coordinates are transformed into screen coordinates of three vertices of a triangle, as shown in step S300.

In step S310, all screen coordinates of the three vertices are rounded into integers.

In step S320, A zero area signal is generated when X integer coordinate of the three vertices are all the same and not in an integer point.

Finally, in step S330, A zero area signal is generated when Y integer coordinate of the three vertices are all the same and not in an integer point.

In step S250, If there is any one triangle need to be reject, the procedure goes back to step S100; otherwise the procedure goes to step S140, as shown in FIG. 4.

As shown in FIG. 3, in step S140, the valid primitives are lighted and textured to vertex information by the lighting and texture stage program 130.

In step S150, if the valid primitives are lighted and textured completely, the procedure goes to step S160; otherwise the procedure goes back to step S140.

Finally, in step S160 the vertex information is submitted to the clip module 160.

The vertex cache 140 and the early rejection after transformation device 150 are used in the present invention. Operating procedures of the vertex shader ALU 110 are divided into the transforming stage program 120 and the lighting stage program 130, wherein a texture transformation is merged into the lighting stage program 130. The vertex cache 140 is used to record current calculating statuses of the vertex shader ALU 110. After a transforming stage of a vertex is finished by the vertex shader ALU 110, another vertex is calculated rather than the lighting stage is activated. Due to the vertex cache 140 is used to store vertex information, transformation data of a former vertex will not be lost when a next vertex is calculated. The lighting stage of the first vertex is operated after the transforming stages of all of the vertices in the vertex cache. The full transformation data can be obtained by the device of early rejection after transformation from the vertex cache at this moment. As a result, redundant triangles are separated, then the redundant triangles are rejected by the vertex cache. Lighting operations of the redundant triangles, which take heavy workload, can be omitted, thus a lot of vertex operations can be saved.

The proposed programmable graphics engine features a unified architecture that can efficiently execute not only vertex shader operations for graphics but also the motion estimation of video coding algorithms. It can achieve the processing speed of 8.3M vertex geometry transformations per second and 6.25M polygons per second with the working frequency of 50 MHz and the power consumption of 20 mW. Furthermore, the floating/fixed-point data path, the reconfigurable memory, and special instructions are designed to be able to accelerate the key operation, motion estimation, in video coding. This powerful graphics and video dual-function programmable engine is shown to be a good solution for multimedia consumer products.

What is claimed is:

1. A system of early rejection after transformation in a Graphics Processing Unit, comprising:
a vertex cache, for receiving vertex data of a triangle from a central processing unit and storing the vertex data;
a vertex shader, for operating the vertex data and related statuses of the vertex data;
a early rejection after transformation device, for determining if the triangle is valid or invalid via referring the related statuses of the vertex data of the triangle;
a lighting and texture stage program, for lighting and texturing the triangle determined valid to vertex information;
an index cache, for receiving index data from a driver to assemble the vertex data into primitives; and
a clip module, for performing a clipping operation on the valid triangle passed by the early rejection after transformation device.

2. The system of early rejection after transformation in a Graphics Processing Unit as recited in claim 1, wherein the early rejection after transformation device has position information of current operating triangle in the vertex cache.

3. The system of early rejection after transformation in a Graphics Processing Unit as recited in claim 1, wherein the early rejection after transformation device can realize where to read the related statuses and to transform three-dimension into two-dimension projection on a screen of a display.

4. The system of early rejection after transformation in a Graphics Processing Unit as recited in claim 1, wherein the early rejection after transformation device can reject an invalid triangle and clip a valid triangle.

5. The system of early rejection after transformation in a Graphics Processing Unit as recited in claim 1, wherein the system is applicable to a portable hand-help device including Digital Still Camera (DSC), Digital Video (DV), Personal Digital Assistant (PDA), mobile electronic device, 3G mobile phone, cellular phone or smart phone.

6. A method of early rejection after transformation in a Graphics Processing Unit, comprising the steps of:
transforming vertex data of primitives into transformed vertex in a clipping space;
transforming the primitives into two-dimension screen position data;
determining the primitives valid or invalid via judging if any one triangle is outside clipping boundary, a back-faced triangle or has zero area by using the two-dimension screen position data;
lighting and texturing the primitives determined valid to vertex information; and
submitting the vertex information.

7. The method of early rejection after transformation in a Graphics Processing Unit as recited in claim 6, wherein the step of determining the primitives valid or invalid, further comprising the steps of:
transforming clipping coordinates into screen coordinates of three vertexes of a triangle;
rounding all screen coordinates into integers;
generating zero area signal when X integer coordinate of the three vertexes are all the same and not in an integer point; and
generating zero area signal when Y integer coordinate of the three vertexes are all the same and not in an integer point.

8. The method of early rejection after transformation in a Graphics Processing Unit as recited in claim 6, wherein the method is applicable to a portable hand-help device including Digital Still Camera (DSC), Digital Video (DV), Personal Digital Assistant (PDA), mobile electronic device, 3G mobile phone, cellular phone or smart phone.
